(19) United States
(12) Patent Application Publication
(10) Pub. No.: US 2013/0262485 A1
(43) Pub. Date: Oct. 3, 2013

(54) High Efficiency Prefix Search Algorithm Supporting Interactive, Fuzzy Search on Geographical Structured Data

(71) Applicants: Chen Li, Irvine, CA (US); Shengyue Ji, Irvine, CA (US)

(72) Inventors: Chen Li, Irvine, CA (US); Shengyue Ji, Irvine, CA (US)

(73) Assignee: THE REGENTS OF THE UNIVERSITY OF CALIFORNIA, Oakland, CA (US)

(21) Appl. No.: 13/993,031

(22) PCT Filed: Dec. 14, 2011
(86) PCT No.: PCT/US11/64842

§ 371 Date: Jun. 10, 2013

Related U.S. Application Data
(60) Provisional application No. 61/423,020, filed on Dec. 14, 2010.

(51) Int. Cl. G06F 17/30

(52) U.S. Cl. CPC G06F 17/30699
USPC 707/754

(57) ABSTRACT

A computer-implemented method for retrieving information from a dataset of multiple records includes the steps of receiving a search phrase from a user or client application, the search phrase having a query keyword prefix, and traversing a multilayered spatial tree using the query keyword prefix until a termination condition occurs. The multilayered spatial tree is constructed using geographic information and has a root node and a plurality of child nodes including a plurality of leaf nodes. Each leaf node is associated with a corresponding list of records. At least some of the nodes are each associated with a corresponding hybrid filter including an object filter and a child filter. The object filter directly points to one or more records, and the child filter points to one or more child nodes for a subsequent traversal step.

### RELATED APPLICATIONS

The present application is related to U.S. Provisional Patent Application Ser. No. 61/423,020 filed on Dec. 14, 2010, which is incorporated herein by reference and to which priority is claimed pursuant to 35 USC 119.

### GOVERNMENT RIGHTS

This invention was made with government support under Grant Nos. 1030002 and IIS0844574 awarded by the National Science Foundation. The government has certain rights in the invention.

### BACKGROUND

1. Field of the Technology

The disclosure relates to methods and apparatus directed to how to improve keyword searches on spatial data by effective filtering and interactive searches.

2. Description of the Prior Art

Instant search has become increasingly popular in many search systems (such as Google Instant Search) due to its user friendly interface and the power to help users explore the data. In these systems, a user can receive instant results as he types in keywords. For instance, when the user types in “metropolitan mus”, the system returns answers that have the keyword “metropolitan” and a keyword with “mus” as a prefix, such as museum.

However, the existing instant search systems, such as Google Instant Search, do not perform a full text based prefix search. Although delivering instant search result at any given partial entry of a keyword has an appearance of performing a prefix search (as opposed to whole word search), the existing instant search does not perform real prefix search. But rather, a whole word search is performed using a predicted keyword.

In the above instance of “metropolitan mus”, for example, instead of treating the partial keyword “mus’ as a real prefix and search over the data corpus for all records containing any of the words having this prefix, the existing search engine performs a whole word search using a particular complete keyword “museum” which is predicted based on the partial keyword “mus”. The prediction is done using the user history query log (rather than the full text of the data itself). In this particular instance, for example, the search engine predicts the keyword to be “museum” based on the search string that has already been entered (“metropolitan mus”), and subsequently performs a search based on this prediction. Because the predicted whole keyword is only a single instance of a potentially large number of all possible keywords that share a common prefix, the search is not a full text-based prefix search. This makes the search very fast, because it does not search over the large data corpus for all possible keywords implicated by the prefix.

However, the speed is achieved by making a fundamental compromise. The relevance and usefulness of the search are limited to the accuracy of the prediction; and because what is being predicted is in the mind of the user, who could be from all kinds of background with all kinds of needs, the prediction cannot be always accurate. Once the prediction is made, all other keywords sharing the common prefix are ignored. These other keywords are not predicted by the search engine, because they do not appear or appear less frequently in the user query log. For example, with a partial entry point of “metropolitan mus”, less commonly searched terms like “metropolitan music” and “metropolitan muster” will not be found.

The benefit of performing full text based prefix search is known in the art. However, the lack of efficient search algorithms has made it difficult to perform such an uncompromising search over a large dataset, particularly in the cases of an instant and fuzzy search. The demand for search algorithm efficiency becomes even more acute when the search is over geographic information due to the particular nature of spatial data.

There is therefore a need to support genuine full text-based instant search on spatial data by efficiently answering prefix queries.

### BRIEF SUMMARY

The illustrated embodiments of the invention include a method and system for an information-access paradigm in which the system searches on the underlying geographical data “on the fly” as the user types in query keywords. It extends autocomplete interfaces by (1) performing real full text based prefix search; (2) supporting queries with multiple keywords on data with multiple attributes; and (3) finding relevant records that may not match query keywords exactly. This framework allows users to explore data as they type, even in the presence of minor errors. The framework is fast enough for the relevant results to be found and mapped in real-time across the internet as the user types each keystroke on a client device.

We have previously developed methods to perform searches with similar functions on non geo-spatial data, but specific challenges exist for geo-spatial data. The first is efficiency. Performing interactive search for each keystroke requires efficient algorithms that process such queries in milliseconds. This problem is particularly difficult for geo-spatial queries, where the result set must be limited to the specific region the user is interested in. Traditional geo-spatial search methods are not fast enough to be used on every keystroke. The second challenge is supporting fuzzy search with an interactive speed.

In the illustrated embodiment we provide a technique to store hybrid prefix filters on spatial-tree nodes using a space-efficient representation. In addition, we show a method to compress the representation in order to further reduce the index size. For both techniques, we also study how to efficiently construct their corresponding index structure, and how to maintain it incrementally in the presence of updates.

The disclosed filtering, pruning and caching technique is able to support extremely fast incremental computation of result sets on a combination and spatial partitioning and trie index structures.

We have developed a real world prototype to demonstrate the speed, user friendliness and efficiency of this search method.

One of the illustrated embodiments is a method to support efficient, interactive, and fuzzy search on structured geo-spatial data. Interactive, fuzzy search on structured geo-spatial data is important in applications such as query relaxation, autocomplete, and spell checking, where inconsistencies and errors exist in user queries as well as data. The embodiment is able to efficiently and interactively answer fuzzy queries on structured geo-spatial data. Existing algorithms cannot support interactive, fuzzy search on such data. After a user types in a query with keywords, these algorithms find records in the geo-spatial database that include these keywords exactly.

The techniques of the illustrated embodiment allow users to efficiently search for information interactively in geo-spatial databases. The user can find records and documents even if these records and documents are slightly different from the user keywords.

Discussed with various embodiments are following techniques to effectively, efficiently, and interactively answer fuzzy search over structured geo-spatial data:
a. Using tree-based indexes to efficiently index the data;
b. Using a unique algorithm to traverse the tree as the user types in a query;
c. Adaptively maintaining the intermediate results for the query to support interactive, fuzzy search;
d. Using a combination of a geo-tree and highly optimized geo-node filters to select relevant regions and relevant keywords effectively; and
e. Using intelligent compression to keep the size of the data structures described above small enough to allow the system to run on commodity hardware.

We have developed an online demonstration called Omniplaces. The goal of Omniplaces is to make it easy to find businesses and places in the United States. It has two search boxes. The first is to enter keywords for a business or place. The keywords can the made of the words from the name of a record, its address, or any other text associated with the record. The second is to specify a target location. The online demonstration illustrates the capabilities of our new search algorithm to support interactive search (searches as you type in the keyword search box); allow minor errors in the keywords; draw map as you type (the search results and suggestions are rendered on the map as you type); limit the search results and suggestions to the area specified in the location box; allow multiple keywords in the keyword box; and provide suggestions on either the first or subsequent keywords.

The illustrated method and system may be used in information systems that need to allow users to interactively search for geo-spatial records even with minor errors. For example, Web sites that have structured geo-spatial data about business or asset locations can benefit from our techniques. Services that allow people to search for people or objects on a map can also use our techniques to make their search more powerful. The disclosed method and system can also be used to allow users to browse data in underlying geo-spatial databases.

The efficient algorithm supports keyword and prefix selection on specific geographic regions. Experimental results on several real data sets show the query performance of algorithms using the disclosed techniques.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a high level structure diagram of primary geo-tree structure used by the method and apparatus of the illustrated embodiments.

FIG. 2 is a tabular diagram providing more detail concerning the high level structure with respect to operation of the O-Filters and C-Filters.

FIG. 3 is a diagram illustrating the Forward Index Structure.

FIG. 4 is a flow diagram illustrating the special case of an exact keyword search.

FIG. 5 is a diagram showing the trie structure used for prefix encoding.

FIG. 6 is a flow diagram illustrating how the O-Filter and C-Filter are used to efficiently find results for geographic prefix searches.

FIG. 7 is a flow diagram which illustrates how the O-Filter and C-Filter are used after compression.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

In this disclosure, “prefix” means a leading portion (including the whole) of a word. A prefix can be a partial word, but in the special case can also be a whole word.

High Level Data Structures

Here we describe the high level data structures used in the implementation of the subsequent search algorithms. We first review the structure of the underlying data. Consider a data set of spatial keyword records. Each record has a record identifier, and multiple attributes, including a spatial attribute and several keyword attributes. The value of the spatial attribute of a record represents the geographical location of the record. This value is typically a point with a pair of latitude a longitude. The keyword attributes are textual strings that can be tokenized into keywords, typically the name of the record, possibly its address, and other labels such as categories.

The table below illustrates conceptually as possible set of such geo-spatial records:

| Record ID | Location | Name | Address |
|---|---|---|---|
| 1 | 40.66, −72.34 | Burger Express | 123 Bin Ave |
| 2 | 38.38, −90.38 | Pizza Hut | 22 Cat St |
| 3 | 41.32, −88.26 | Starbucks | 888 Main st |
| . . . | . . . | . . . | . . . |

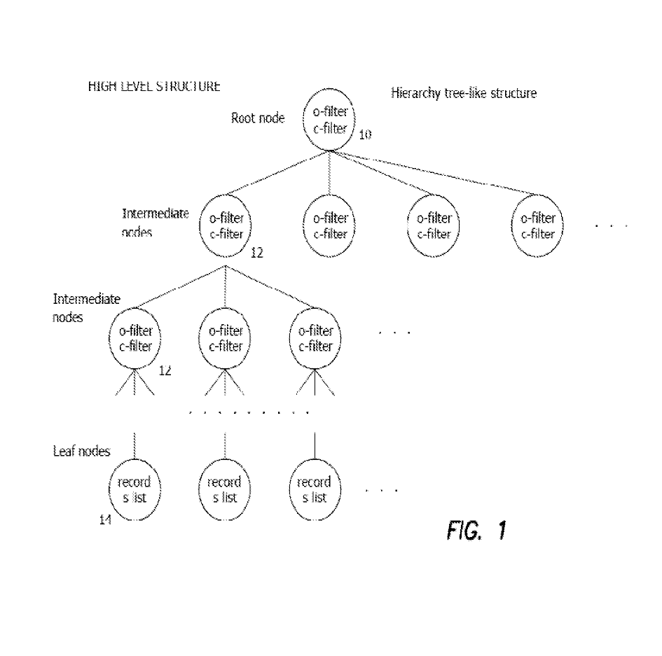

Consider a large set S of such geo-records. Large in our context refers to set ranging from several million to many billion records. For comparison and reference, there are approximately 15 to 20 million businesses in the United States. We represent the set S using is a geo-spatial hierarchy tree-like structure, which partitions the space into some smaller geographical subdivisions at each level as shown in FIG. 1. For example, in FIG. 1, node 10 could represent a country. Intermediate nodes 12 and can represent regions and sub-regions. In the following we refer to this structure as the geo-tree. In the illustrated embodiment we use a structure similar to a quad-tree, a well known computer science data structure where each node has exactly four children. In our case the number of subdivision is a parameter and we have determined through experimentation that the optimal value is 16. However, our method does not depend on the particular definition of the tree-like structure, and can be used with other such structures such as an RB tree.

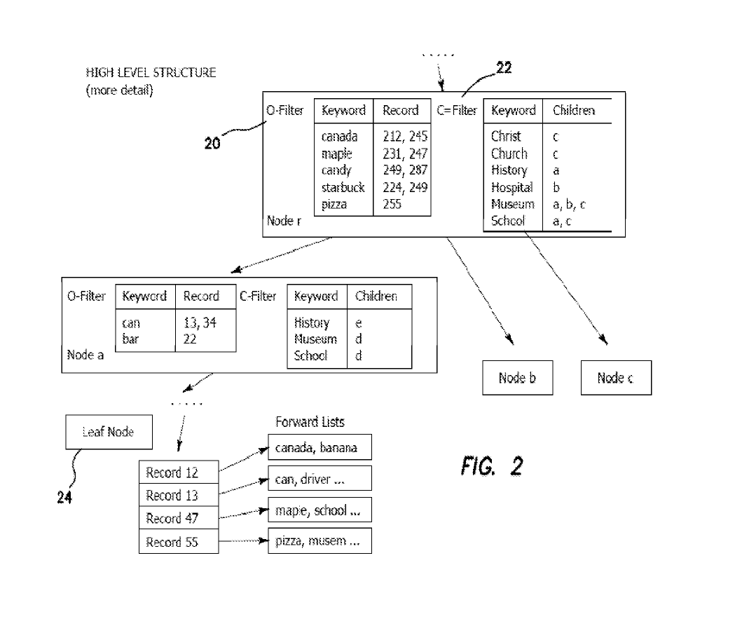

We subdivide each node into children until the number of records is lower than a minimum threshold Rₘₐₓ. On the lowest level, at each leaf node, we store the records belonging to the spatial region of that node as shown in FIG. 2 in leaf node 24. At other nodes on all other levels, the non-leaf nodes, we store the bounding box corresponding to the geographic location of the node, and a hybrid filter including two kinds of filters. The bounding box and filters are control data structures used to implement the algorithms themselves. The two kinds of filters in the hybrid filter are called Object filter or O-Filter, and Child filter or C-Filter. The high level structure is shown in the diagram of FIG. 1 moving from root nodes 10, to intermediate nodes 12 and finally to leaf nodes 14.

As illustrated in FIG. 2 each O-Filter (object filter) directly points to one or more records, and each C-Filter (child filter) points to one or more child nodes for a subsequent traversal step. The O-Filter 20 maps keywords with direct pointers to the records 212, 245, 231, 247 (these numbers are not consistent with the figure), etc. The O-Filter is preferably highly selective. The selectivity may be defined by a selectivity threshold, which is the maximum number of records each O-Filter entry is allowed to point to. For example, if we define the selectivity threshold to be three, then for a keyword prefix “foo”, only if we have less or equal than three records containing “foo” in this region and it's children, will “foo” be on the O-Filter linked to these records. O-Filters store a mapping between keyword intervals (described below) and records. They are used to search for very selective keywords. During the traversal of the geo-tree of FIG. 1, they allow jumping from intermediate nodes 12 directly to the records in leaf node 14, thereby dramatically reducing computation times.

C-filters store a mapping between keyword intervals and geo-tree intermediate nodes 12. The C-Filter 22 maps keywords to intermediate no a, b, and c. During the traversal of the geo-tree, these filters are used in conjunction with the bounding box of each intermediate node to decide efficiently which children node to continue on to when we cannot find the keywords on the O-Filter.

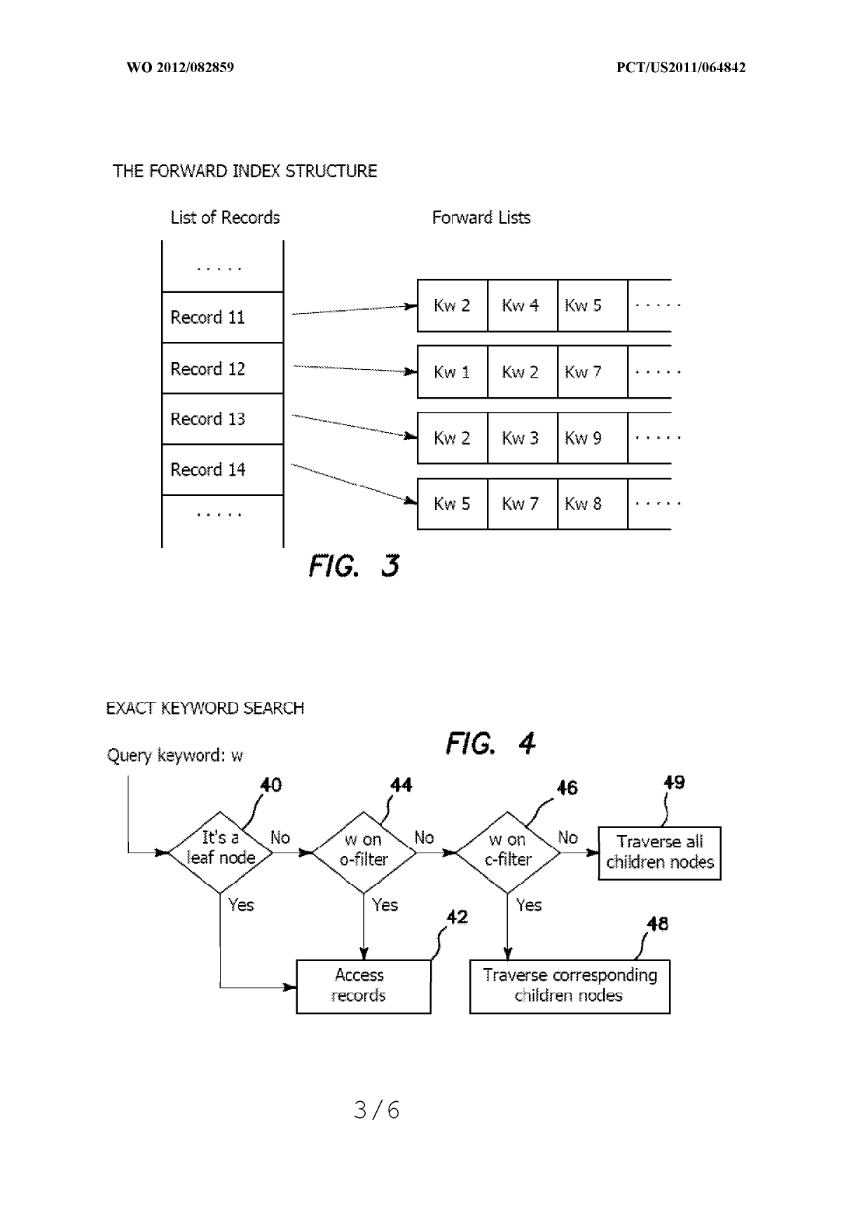

Each leaf node 14 contains a data structure called Forward Index as shown in FIG. 3. The forward index contains the list of the record identifiers in the leaf node 14. In addition, for each record, it stores a “Forward list” that contains the identifiers of all the keywords that this record contains. This data structure is mainly for the purpose of doing verification in the search process.

Exact Keyword Search

The algorithm used to perform extremely efficient exact match search for geo-spatial queries is illustrated in FIG. 4. This can be viewed as a special case application of the disclosed search algorithm.

For any incoming query, we start by encoding the keywords into intervals. That specific algorithm is described in detail below under Prefix Encoding. With the query keywords encoded as intervals, we start traversing the geo-tree from the root with the purpose of efficiently focusing on the regions that match both the query keywords and the query location. At step 40 if the node is a leaf node, the record is accessed at step 42. Otherwise a test is made at step 44 whether the keyword, w, is on an O-Filter 12. If it is, then the record is accessed at step 42. Otherwise a test is made at step 46 whether the keyword, w, is on a C-Filter 12. At each intermediate geo-tree node 12, we have an O-Filter storing all the keywords which are very selective in the geographic region corresponding to that node. For instance, if there is only one record in that region that has the keyword “candy”, then “candy” will be on the O-Filter linked to that record directly.

We first search the query keyword on the O-Filter. If the keyword searched by the user is not on the O-Filter as determined at step 44, we then look for it on the C-Filter at step 46. The C-Filter will tell us which sub-regions of the node contain records that match the selected keyword. For instance, if the first and third subdivisions contain some records that have “Canada” as keyword, and the number of these records is sufficiently large that “Canada” is not selective enough to be on the O-Filter, we then will have “Canada” on the C-Filter pointing to the children nodes corresponding to the first and third subdivisions. Next, we filter the result of the C-Filter selection by verifying if the bounding box of the qualifying child nodes contains the bounding box of the query at step 48. Otherwise all children nodes are traversed at step 49. This mechanism effectively implements the geographic aspect of the search very efficiently. Search result verification may be further performed using the Forward Index stored at each leaf.

Prefix Encoding

Consider the method used to encode the prefix of the keywords. We use a trie data structure to store the dictionary of keywords for all the searchable records. In our search algorithm, we view each keyword as a prefix corresponding to a node of the trie of our dictionary. Each trie node denotes a prefix. It should be noted that we treat a complete word as a special case of a prefix. Each prefix or trie node is further encoded into an integer interval [minId, maxId]. The lowest bound of the interval minId is the smallest keyword ID under the sub-tree of this node. The highest bound maxId is that largest keywords ID under the sub-tree of this node. Although there is no special requirement of the format for keyword ID, it is preferably sequential for easier management. The keyword ID can be alphanumerical, and in the used implementation can be simply an integer.

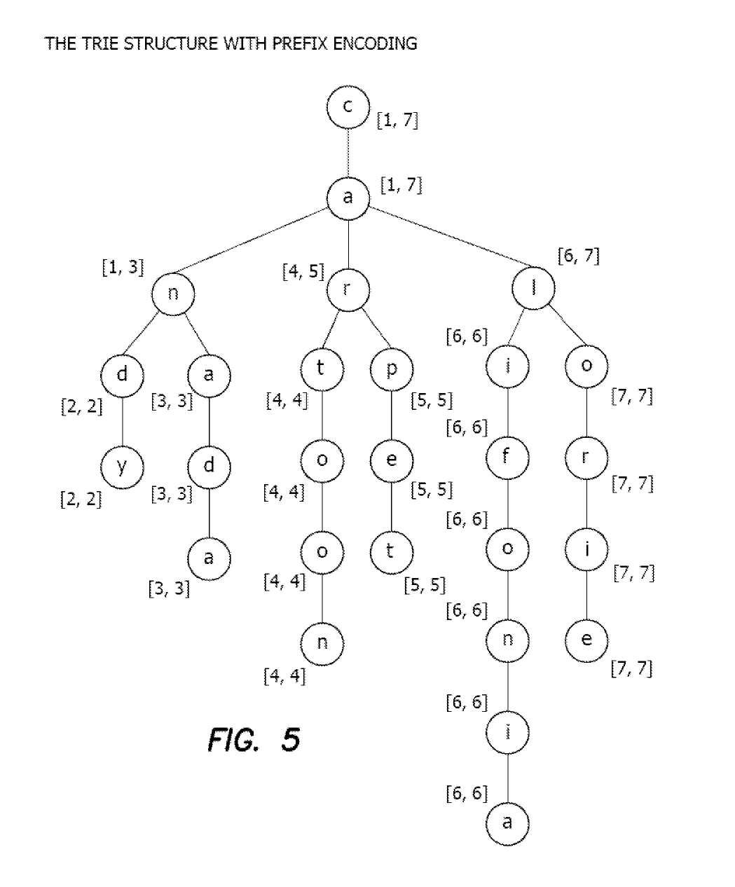

To illustrate turn to FIG. 5 and consider an example where we have 7 words in our dictionary and each of them has a keyword ID: 1. can, 2. candy, 3. canada, 4. cartoon, 5. carpet, 6. california, and 7. calorie. The prefix and trie node “n”, corresponding to the 3^{rd} letter of the words “can”, “candy”, and “canada”, is encoded into [1, 3] because the smallest keyword ID under it is 1 for “can” and the largest keyword ID is 3 for “canada”.

As a result of this encoding, many different nodes in the trie have the same intervals. Thus these nodes are logically identical inside the search algorithm, which allows us to implement prefix search.

Prefix Search

Consider the algorithm used to implement prefix search using the prefix encoding described above. We previously explained that when traversing the geo-tree, we search for each keyword against the O-Filter and C-Filter of each geo node reached, in that order. If the keyword is found in the O-Filter, we directly get the desired record we without traversing the entire path from that node to the leaf node. If not, then we search it on C-Filter and find it there, so we know which children nodes to go to continue our search.

The interval encoding is used to perform these two keyword searches on the O-Filter and C-Filter. When we look for a keyword on filters, we actually look for the prefix interval corresponding to that keyword. We store all keywords as intervals on filters and all the intervals are ordered by this rule: for two intervals I₁ and I₂, I₁<I₂ if (minId₁<minId₂) or (minId₁=minId₂ and minId₁>minId₂). This allows us to search for the keyword using a binary search thereby allowing us to find the keyword very efficiently.

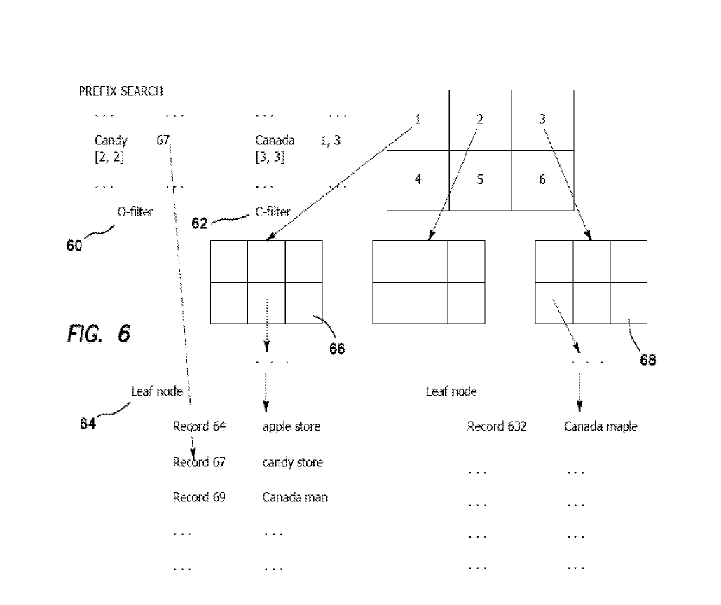

We illustrate using an example, on FIG. 6. When searching for “candy”, we actually search for the interval [2,2] on the O-Filter 60. And when searching for “Canada”, we actually search for the interval [3,3] on the C-Filter 62.

So if we have “candy” as query keyword, we encode as interval [2,2], then search it against the O-Filter 60 and find it there. From there we jump directly to record 67 without having to walk whole path from that node to the leaf node 64.

If we have “Canada” as query keyword when encode it as interval [3,3] then search it against the O-Filter 60 but can't find it there. We then proceed to search it on the C-Filter 62 and find it there. So we now know we need to go to the first child node 66 and third child node 68 to continue our search. So we proceed to these two child nodes to perform the same prefix search there.

Compression

Consider the compression method used to keep the interval storage in the O-Filter and C-Filter within reasonable and acceptable limits that allows running geo-search queries on commodity computers with reasonable amount of memory. We explained earlier that keywords are stored in the O-Filter when they are “very selective”. That definition of selectivity is controlled by a selectivity threshold, which may be represented by the maximum number of records each O-filter keyword prefix may point to. For instance, if we set the selectivity threshold to three, then keywords will be stored in the O-Filter if and only if they are present at most three times in the region covered by this geo-node.

To reduce the memory usage of the O-Filters, we perform compression by combining those keywords that have the same prefix. For instance, if the selectivity threshold is three, and we have “candy” in one record in this region and “Canada” in two records in this region, then instead of storing “candy” and “Canada” as two separate keywords in the o-filter, we store the prefix “can” in the O-Filter linked to a list containing these three records because the prefix “can” still meets the selectivity threshold requirement even after combining the records pointed to by “candy” and “Canada”.

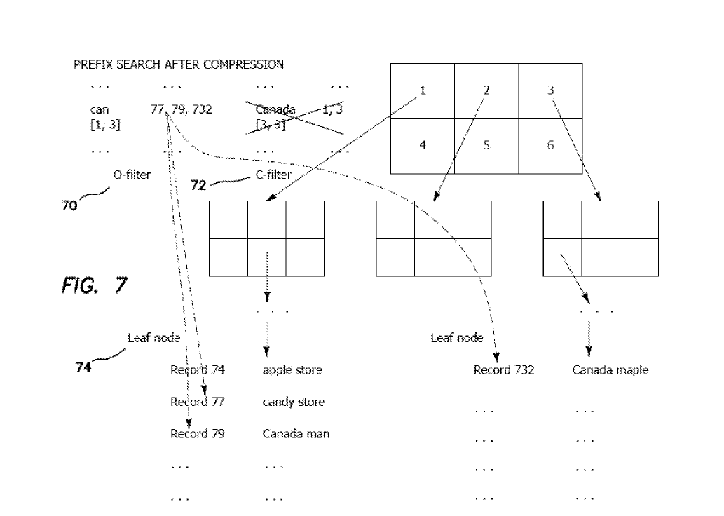

In addition, we use ancestors to represent descendants (trie-wise) to further reduce the memory usage. In our example, since we have “can” on the O-Filter and that allows us to search for all keywords that have “can” as prefix for this whole region, there is no need to store any other keywords having “can” as prefix on either O-Filters or C-Filters on this node or on any of its descendant nodes. For example, we can remove “Canada” from C-Filter node 72 on FIG. 7 and from the filters of all the descendants.

To further reduce the space usage for C-Filter, we may also set up a selectivity threshold for the C-Filter. This threshold works in a different way from the previous one described on the O-Filters. Keywords are removed from the C-Filter storage when they exceed the selectivity threshold, for example appear in a number of children regions that is greater than the threshold. When we fail to find these keywords on C-Filter, we then navigate to every children node to continue the search. The same mechanism is used to remove the keywords from the C-Filter store when they do not appear in any of the sub-regions of a node.

Prefix Search after Compression

We explain the algorithm for prefix search on compressed O-Filters and C-Filters using an example, which is illustrated on FIG. 7. Suppose the inbound query keyword is “cana”. We use our prefix encoding method to encode the query keyword. This gives us that the interval corresponding to “cana” is [3,3]. Suppose also we have traversed the geo-tree to a node that contains an O-Filter with the following encoded prefixes:

. . . can[1, 3], car[4, 5], california[6, 6] . . .

We search for [3,3] on the O-Filter. First we perform an upper bound search. This gives us the first position in the O-Filter with an interval bigger than what we are looking for. In our example, this gives car[4,5]. Then we do a decrement this position by 1. In our example, this gives can[1,3]. Then we verify if can[1,3] is indeed a prefix of “cana”. Therefore we find can[1,3] on the O-Filter.

When the prefix verification passes, we have a matching entry in the O-Filter. In this case we can jump to the corresponding list of records pointed to by this entry. In our example can[1,3] in the O-Filter 70 points to the three records 74, 77 and 79. We navigate to each record and perform a bounding box location check to verify if they are in the query range of the geographic location.

For those records that pass the location check, the final step is the keyword verification. The keyword verification is performed by the forward index stored in each record. Each record's forward list stores the record's keywords as ordered keyword identifiers. To verify if a prefix is actually contained by any keyword of a record, we only need to do one binary search.

In our example, for record 79 and record 732, we verify that they both have “canada” as a keyword, which has “cana” as prefix. For record 77, we have “candy” and “store” as keywords but none of them contain “cana” as prefix. Therefore we get record 79 and record 732 as the final query results and record 77 is eliminated. In the case where we do not have a match on the O-Filter 70, we move on to search against the C-Filter 72. The search on the C-Filter is the same as on the O-Filter. We search the prefix on the C-Filter using and upper bound search, then a decrement. This returns the children nodes, if any, that the keyword points to.

In the case where we cannot find any matching keywords on either the O-Filter or the C-Filter, we continue down and repeat the same prefix search on every child node. If we reach a leaf node, we just get the list of records on that node and the location verification and keyword verification steps for each record one by one.

Handling of Multi-Keywords Queries

Consider the algorithm used that handle queries with multiple keywords. For those queries with more than one keyword, we first use a heuristic to pick a single primary keyword and perform a prefix search on that keyword as described previously. Then, when we perform the keyword verification step, we verify not only the primary keyword but also all the other keywords in the query to verify if they are also present in the result records. This allows us to efficiently eliminate those result records that do not contain all the keywords.

To illustrate with an example turn to FIG. 6 and suppose the incoming query has two keywords or prefixes: “cana” and “mapl”. Let us assume the keyword selection heuristics lead us to select “cana” as the primary keyword. Through the search of “cana” that we did previously, we find record 69 “canada man” and record 632 “canada maple”. We then perform the keyword verification for the keyword “cana”. We can see that both records in the result set pass. We then perform the verification for keyword “mapl”. Now we can see that record 632 passes the verification and that record 69 is eliminated. So our final result for this query is record 632.

Many heuristics are available to pick the primary keyword use to perform the first search. For example, among all the keywords that we can find on the O-Filter, we pick the one that is linked with the fewest records. This has the advantage of minimizing the number of verifications we have to perform later. If we can't find any of the query prefixes on the O-Filter, we move on to searching against the C-Filter. We search the C-Filter for each prefix in the query. Then, we perform an AND operation between the results of each C-filter search. This allows us to minimize the number of nodes that we need to proceed to attempt the next O-Filter search.

To illustrate, if we find “cana” on a C-Filter pointing to the 1st and 3rd child node and “mapl” pointing to the 3rd and 5th child node, then we only proceed only to the 3rd child node. Similarly if we find “cana” on a C-Filter pointing to 1st and 3rd child node and can't find “mapl” at that C-Filter, which is treated as found on all children node, then we proceed to both the 1st and 3rd child node. On every child node we continue with the primary keyword search.

Algorithm of Multi-Keywords Prefix Search

Consider the algorithm of the multi-keyword prefix search.

If the current node is leaf node:

a. For each record on the list
b. Check if the location of that record is inside the query
range bounding box
c. Verify if this record indeed contains all the query prefixes
d. Else
e. Among all query prefixes
f. Pick the best one Pbest, which has the smallest number of
records linked with on the O-Filter
g. If Pbest exists (at least one prefix is on o-filter)
h. For each candidate on the list of Pbest
i. Check if the location of that record is inside
the query range
j. Verify if this record indeed contains all the
query prefixes
k. Else
I. Search each prefix on the C-Filter
m. Go to the children nodes that pointed by all prefixes on c-filter
to repeat the same search process (ignore those prefixes that can't be
found on c-filter)

Fuzzy Search

Consider the method used to implement fuzzy (approximate) search. We implement fuzzy search in two steps.

Step 1—calculate keyword expansions: For each query keyword prefix, we use the prefix trie to find all the prefixes that have an edit-distance e from this query keyword prefix. Here e is a parameter and a function of the length of the query keyword prefix. Usually, a longer the prefix may have a larger edit-distance e. To illustrate using our previous keyword, if the query keyword prefix is “cana” and e is 1, then the search on the prefix trie will return “can”, “canad” and “cand”.

We call these additional keywords “expansions”. We calculate the expansions for each keyword in the query, so each original query keyword is associated with a set of expansions that include the original query keyword itself.

Step 2—perform the search on the expansion set: Next we bring all the expansions to the search process. The search process is the same as for our exact keyword search except for a three differences explained below.

With an exact search, we used the number of records linked to in the O-Filter as the first heuristic to choose the primary keyword. For fuzzy search, we change this heuristic to instead use the sum of the number of records on the O-Filter linked to each expansion. The smallest sum determines the primary keyword. Then, we perform the search, and we use each expansion of the primary keyword instead of the keyword itself.

To illustrate an example, suppose we have a query with two keyword prefixes “cana” and “mapl”. For “cana”, suppose we calculate the following expansions: {“cana”, “can”, “canad”, “cand”}. Suppose further we find the expansion “can” on the O-Filter linked with two records. We can't find the expansions “canad”, “cand” and “cana” on the O-Filter because they all have “can” as prefix. Here the sum of the number of records for all expansions is two. For “mapl”, suppose we calculate the expansions {“map”, “maple”, “mapl”}. Let's assume we can't find the expansion “map” on O-Filter and we have expansion “maple” on the O-Filter linked with one record. In this case the sum of the number of records for all expansions is one. In this example, we choose the query prefix “mapl” as the primary keyword because it points to a smaller number of records than the current prefix “can”.

For an exact search, during the keyword verification step, we perform an AND of the verifications of each query prefix. For fuzzy search we replace this with an AND operation of the verifications of the each query prefix, and an OR operation of the expansions of a same prefix. To illustrate, suppose we have a query with two keywords “cana” and “mapl”. Suppose for “cana” we calculated the expansions {“can”, “canad”, “cand”, “cana”}, and for “mapl” we calculated the expansions {“map”, “maple”, “mapl”}. Suppose also we “mapl” as the primary keyword to perform the search, and “maple” is the only expansion we find on O-Filter for the query prefix “mapl”. We find record 632 “canada maple” which is linked with “maple” on the O-Filter. Suppose this record passes the location check and we need to verify it. For the keyword “cana”, we try each of its expansions one by one. Once we get one expansion that passes the verification, we are done with this query prefix, which means the record passes the verification of this query prefix and we can move to the next query prefix. The keyword “mapl” is used as the primary keyword, so for verification we only need to consider its expansions, which in this case are the single expansion “maple”. If there is a third keyword in the query, we need to do the same verification as the one we did for “cana”. A record is included in the final result set only if it passes verification of at least one expansion for every query prefix.

For the fuzzy search, the C-Filter search logic uses an OR approach similar to the one described abode for the fuzzy search verifications. C-Filter values point to a set of child nodes in a geo-tree node. We use a bit vector to represent these values. Each bit corresponds to one child node. If we have “can” on c-filter pointing to first and third child node, the bit vector will be 101000, in which digital the first and the third positions each has digit “1” to indicate a positive. If we have “maple” on c-filter pointing to third and fifth child node, the bit vector will be 001010. If we have “candy” on c-filter pointing to second and fifth child node, the bit vector will be 010010. If we don't have “canada” on c-filer, the bit vector will be 111111.

To calculate the union of the sub-regions that correspond to a set of expansions, we perform a n OR operation between their C-Filter bit vectors. For example:
a. can|maple=101000|001010=101010
b. candy|canada=010010|111111=111111

Then, we perform an AND operation over the results of these ORs for each query keyword. For example:

(can|maple) & (candy|canada)=101010 & 111111=101010

In this case, we need to proceed to the first, third and fifth child nodes to continue the search. This method allows us to find the regions that approximately match the query keywords extremely efficiently.

Algorithm of Fuzzy Search

Consider the algorithm of fuzzy search.

If the current node is leaf node, for :each record on the list

a. Check if the location of that record is inside the query range
b. Verify for each query prefixes, if there is at least one
expansion contained by the record
c. Else
d. Among all query prefixes, pick the best one Pbest
e. If Pbest exists (at least one expansion is on the O-Filter)
f. For each expansion Pbest, j of Pbest that's on the O-Filter
g. For each candidate on the list of Pbest, j
h. Check if the location of that record is inside the query
range
i. Verify for each query prefixes except Pbest, if there is at least
one expansion contained by the record
j. Verify if Pbest, j is indeed contained by the record
k. Remove Pbest, j as the expansion of Pbest
l. If Pbest has expansions left (not on the O-Filter)
m. Search each prefix on C-Filter
n. go to the children nodes that pointed by all the prefixes'
at least one expansion on C-Filter to repeat the same search process
(ignore those prefixes that have expansions that can't be found on
C-Filter)
o. Else
p. Search each prefix on the C-Filter
q. go to the children nodes that pointed by all the prefixes' at
least one expansion on the F-Filter to repeat the same search process
(ignore those prefixes that have expansions that can't be found on
the C-Filter)

In summary, the illustrated embodiment is directed to a computer-implemented method for retrieving information from a dataset of multiple records. The method comprises the steps of receiving a search phrase from a user or client application. The search phrase has a query keyword prefix. A multilayered spatial tree is traversed using the query keyword prefix until a termination condition occurs. The multilayered spatial tree is constructed using geographic information and having a root node and a plurality of child nodes, including a plurality of leaf nodes. Each leaf node is associated with a respective list of records. At least some of the above nodes are each associated with a respective hybrid filter, which includes an object filter and a child filter. The object filter directly points to one or more records, and the child filter points to one or more child nodes for a subsequent traversal step.

The object filter includes a highly selective filtering word in a region of interest indicated by the respective node such that the filtering word points to no more than a maximum number of records. The maximum number is preset.

The object filter is compressed such that the highly selective filtering word is stored in the object filter in replacement of a plurality of preliminary filtering words. The highly selective filtering word points to a combined number of records, which are combined from records pointed to by the plurality of preliminary filtering words, given that the combined number is no greater than the maximum number.

The child filter includes a less selective filtering word in a region of interest such that the filtering word points to no more than a maximum number of children nodes. The maximum number is preset.

The step of traversing the multilayered spatial tree at each node associated with the respective hybrid filter comprises the steps of finding the query keyword prefix through the object filter associated with the node; and if the query keyword prefix is not found in the object filter, finding the query keyword prefix through the child filter associated with the node.

The method further comprises the steps of encoding each filtering word included in the respective hybrid filter of each node using a dictionary trie constructed by tokenizing the dataset such that the filtering word is represented by a respective interval defined by the filtering word's beginning node and ending node on the dictionary trie, and encoding the query keyword prefix using the dictionary trie such that the query keyword prefix is represented by a respective interval defined by the query keyword prefix's beginning node and an ending node on the dictionary trie.

The step of traversing the multilayered spatial tree at each node associated with a respective hybrid filter comprises the step of searching the query keyword prefix through the object filter associated with the node by comparing the interval of the query keyword prefix and the intervals of the filtering words in the object filter, and if the query keyword prefix is not found in the object filter, searching the query keyword prefix through the child filter associated with the node by comparing the interval of the query keyword prefix and the intervals of the filtering words in the child filter.

The intervals are each a numerical interval, and searching the query keyword prefix through the hybrid filter comprises the step of performing a binary search.

The termination condition is defined as a successful identification of a record, and the method further comprises the step of verifying that the identified record has the query keyword prefix.

The keywords contained in the multiple records record are each represented by a keyword ID.

Each record is represented by a forward list which stores the keyword IDs of keywords contained in the record.

The keyword ID of each keyword is a unique integer assigned to the respective keyword. The method further comprises the steps of constructing a dictionary trie by tokenizing the dataset, and encoding each node of the dictionary trie such that each node is represented by a respective interval defined by a shortest keyword ID and a longest keyword ID corresponding to the node.

The method further comprises the steps of associating with each record a forward list storing keyword IDs of keywords contained in the record, encoding the query keyword prefix using the dictionary trie such that the query keyword prefix is represented by the interval representing the node which corresponds to the query keyword prefix, and verifying that the query keyword prefix is contained in an identified record by comparing the respective interval of the query keyword prefix with the forward list associated with the identified record.

The search phrase has a plurality of query keyword prefixes. The method further comprises the steps of traversing the multilayered spatial tree using each of the plurality of query keyword prefixes until a termination condition occurs, if any of the plurality of query keyword prefixes is found through an object filter which points to a record containing the query keyword prefix, verifying that the rest of the plurality of query keyword prefixes is also contained in the record, and if none of the plurality query keyword prefixes is found through an object filter, performing an AND operation among child filter search results of the plurality of query keyword prefixes.

The method is based on a heuristic condition, namely selecting one from the plurality of query keyword prefixes to be the first query keyword prefix to traverse the multilayered spatial tree.

The heuristic condition includes the step of preferentially selecting a query keyword prefix that is linked to a greater number of records through the object filter.

The method further comprises the steps of expanding the query keyword prefix to a prefix expansion including a plurality of prefixes that each have an edit-distance e from the query keyword prefix, traversing the multilayered spatial tree using the prefix expansion until a termination condition occurs, and performing an OR operation among the plurality of prefixes in the same prefix expansion.

The query keyword prefix is a partial word. The step of traversing the multilayered spatial tree using the query keyword prefix is automatically started before the user or client application finishes entering the complete word.

The illustrated embodiment is also a computer-implemented method for retrieving information from a dataset of multiple records comprising the steps of constructing a multilayered spatial tree using geographic information and having a root node and a plurality of child nodes including a plurality of leaf nodes each associated with a respective list of records, wherein at least some nodes are each associated with a respective hybrid filter including an object filter and a child filter, the object filter directly pointing to one or more records, and the child filter pointing to one or more child nodes for a subsequent traversal step, receiving a search phrase from a user or client application, the search phrase having a query keyword prefix, and traversing a multilayered spatial tree using the query keyword prefix until a termination condition occurs.

Each object filter includes a highly selective filtering word in a region of interest indicated by the respective node such that the filtering word points to no more than a maximum number of records. The maximum number is preset.

The keywords found in the multiple records record are each represented by a keyword IDs. The method further comprises the steps of constructing a dictionary trie by tokenizing the dataset, and encoding each node of the dictionary trie such that each node is represented by a respective interval defined by a shortest keyword ID and longest keyword ID corresponding to the node.

The method further comprises the step of encoding the query keyword prefix using the dictionary trie such that the query keyword prefix is represented by the interval representing the node which corresponds to the query keyword prefix.

The search phrase includes a plurality of query keyword prefixes. The method further comprises the steps of traversing the multilayered spatial tree using the plurality of query keyword prefixes until a termination condition occurs, if any of the plurality of query keyword prefixes is found through an object filter which points to a record containing the query keyword prefix, verifying that rest of the plurality of query keyword prefixes is also contained in the record, and if none of the plurality of query keyword prefixes is found through an object filter, performing an AND operation among child filter search results of the plurality of query keyword prefixes.

The method further comprises the steps of expanding the query keyword prefix to a prefix expansion including a plurality of prefixes that has an edit-distance e from the query keyword prefix, traversing the multilayered spatial tree using the prefix expansion until a termination condition occurs, and performing an OR operation among the plurality of prefixes in the same prefix expansion.

The scope of the illustrated embodiment also extends to include a computer-implemented information retrieval system for retrieving information from a dataset of multiple records. The system comprises a frontend module for receiving and parsing a search phrase from a user or client application, the search phrase having a query keyword prefix, and a backend module for traversing a multilayered spatial tree using the query keyword prefix until a termination condition occurs. The multilayered spatial tree is constructed using geographic information and having a root node and a plurality of child nodes including a plurality of leaf nodes each associated with a respective list of records. At least some nodes are each associated with a respective hybrid filter including an object filter and a child filter. The object filter directly points to one or more records, and the child filter points to one or more child nodes for a subsequent traversal step.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A computer-implemented method for retrieving information from a dataset of multiple records, the method comprising:
receiving a search phrase from a user or client application, the search phrase having a query keyword prefix; and
traversing a multilayered spatial tree using the query keyword prefix until a termination condition occurs, the multilayered spatial tree being constructed using geographic information and having a root node and a plurality of child nodes including a plurality of leaf nodes, each leaf node being associated with a corresponding list of records, wherein at least some of the nodes are each associated with a corresponding hybrid filter including an object filter and a child filter, the object filter directly pointing to one or more records, and the child filter pointing to one or more child nodes for a subsequent traversal step.

2. The computer-implemented method of claim 1, wherein traversing the multilayered spatial tree, each object filter includes a highly selective filtering word in a region of interest indicated by the corresponding node such that the filtering word points to no more than a maximum number of records, the maximum number being preset.

3. The computer-implemented method of claim 2, wherein traversing the multilayered spatial tree, the object filter is compressed such that the highly selective filtering word is stored in the object filter in replacement of a plurality of preliminary filtering words, the highly selective filtering word pointing to a combined number of records which include records pointed to by the plurality of preliminary filtering words given that the combined number is no greater than the maximum number.

4. The computer-implemented method of claim 1, wherein traversing the multilayered spatial tree, each child filter includes a less selective filtering word in a region of interest such that the filtering word points to no more than a maximum number of children nodes, the maximum number being preset.

5. The computer-implemented method of claim 1, wherein traversing the multilayered spatial tree at each node associated with the corresponding hybrid filter comprises:
finding the query keyword prefix through the object filter associated with the node; and
if the query keyword prefix is not found in the object filter, finding the query keyword prefix through the child filter associated with the node.

6. The computer-implemented method of claim 1, further comprising:
encoding each filtering word included in the corresponding hybrid filter of each node using a dictionary trie constructed by tokenizing the dataset such that the filtering word is represented by a corresponding interval defined by the filtering word's beginning node and ending node on the dictionary trie; and
encoding the query keyword prefix using the dictionary trie such that the query keyword prefix is represented by a corresponding interval defined by the query keyword prefix's beginning node and an ending node on the dictionary trie.

7. The computer-implemented method of claim 6, wherein traversing the multilayered spatial tree at each node associated with a corresponding hybrid filter comprises:
searching the query keyword prefix through the object filter associated with the node by comparing the interval of the query keyword prefix and the intervals of the filtering words in the object filter; and
if the query keyword prefix is not found in the object filter, searching the query keyword prefix through the child filter associated with the node by comparing the interval of the query keyword prefix and the intervals of the filtering words in the child filter.

8. The computer-implemented method of claim 7, wherein searching the query keyword prefix, the intervals are each a numerical interval, and searching the query keyword prefix through the hybrid filter comprises performing a binary search.

9. The computer-implemented method of claim 1, wherein traversing a multilayered spatial tree, the termination condition comprises a successful identification of a record, and the method further comprising:
verifying that the identified record has the query keyword prefix.

10. The computer-implemented method of claim 1, where the dataset of multiple records include a plurality of keywords, and wherein traversing the multilayered spatial tree corresponding to the dataset, each keyword contained in the multiple records is represented by a keyword ID.

11. The computer-implemented method of claim 10, where each record in the dataset is represented by a forward list storing the keyword IDs of the keywords contained in the record, wherein traversing the multilayered spatial tree in order to verify if a prefix is actually contained by any keyword of a record, only one binary search is performed.

12. The computer-implemented method of claim 10, where each keyword ID of the keyword is a unique integer assigned to the corresponding keyword, the method further comprising:
constructing a dictionary trie by tokenizing the dataset; and
encoding each node of the dictionary trie such that each node is represented by a corresponding interval defined by a shortest keyword ID and a longest keyword ID corresponding to the node.

13. The computer-implemented method of claim 12, further comprising:
associating with each record a forward list storing keyword IDs of keywords contained in the record;
encoding the query keyword prefix using the dictionary trie such that the query keyword prefix is represented by the interval representing the node which corresponds to the query keyword prefix; and
verifying that the query keyword prefix is contained in an identified record by comparing the corresponding interval of the query keyword prefix with the forward list associated with the identified record.

14. The computer-implemented method of claim 1, where the search phrase has a plurality of query keyword prefixes, the method further comprising:
traversing the multilayered spatial tree using each of the plurality of query keyword prefixes until a termination condition occurs;
if any of the plurality of query keyword prefixes is found through an object filter which points to a record containing the query keyword prefix, verifying that the rest of the plurality of query keyword prefixes is also contained in the record; and
if none of the plurality query keyword prefixes is found through an object filter, performing an AND operation among child filter search results of the plurality of query keyword prefixes.

15. The computer-implemented method of claim 14, further comprising selecting one from the plurality of query keyword prefixes to be the first query keyword prefix to traverse the multilayered spatial tree based on a heuristic condition.

16. The computer-implemented method of claim 15, where selecting one from the plurality of query keyword prefixes based on a heuristic condition comprises preferentially selecting a query keyword prefix that is linked to a greater number of records through the object filter.

17. The computer-implemented method of claim 1, further comprising:
expanding the query keyword prefix to a prefix expansion including a plurality of prefixes that each have an edit-distance e from the query keyword prefix;
traversing the multilayered spatial tree using the prefix expansion until a termination condition occurs; and
performing an OR operation among the plurality of prefixes in the same prefix expansion.

18. The computer-implemented method of claim 1, where the query keyword prefix is a partial word, and wherein traversing the multilayered spatial tree using the query keyword prefix is automatically started before the user or client application finishes entering the complete word.

19. A computer-implemented method for retrieving information from a dataset of multiple records, the method comprising:
constructing a multilayered spatial tree using geographic information and having a root node and a plurality of child nodes including a plurality of leaf nodes, each node associated with a corresponding list of records, wherein at least some nodes are each associated with a corresponding hybrid filter including an object filter and a child filter, the object filter directly pointing to one or more records, and the child filter pointing to one or more child nodes for a subsequent traversal step;
receiving a search phrase from a user or client application, the search phrase having a query keyword prefix; and
traversing a multilayered spatial tree using the query keyword prefix until a termination condition occurs.

20. The computer-implemented method of claim 19, wherein constructing a multilayered spatial tree having a root node and a plurality of child nodes and leaf nodes with at least some nodes associated with an object filter, each object filter each includes a highly selective filtering word in a region of interest indicated by the corresponding node such that the filtering word points to no more than a maximum number of records, the maximum number being preset.

21. The computer-implemented method of claim 19, wherein each of the keywords found in the multiple records is represented by a keyword ID, the method further comprising:
constructing a dictionary trie by tokenizing the dataset; and
encoding each node of the dictionary trie such that each node is represented by a corresponding interval defined by a shortest keyword ID and longest keyword ID corresponding to the node.

22. The computer-implemented method of claim 21, further comprising:
encoding the query keyword prefix using the dictionary trie such that the query keyword prefix is represented by the interval representing the node which corresponds to the query keyword prefix.

23. The computer-implemented method of claim 19, wherein the search phrase includes a plurality of query keyword prefixes, the method further comprising:
traversing the multilayered spatial tree using the plurality of query keyword prefixes until a termination condition occurs;
if any of the plurality of query keyword prefixes is found through an object filter which points to a record containing the query keyword prefix, verifying that rest of the plurality of query keyword prefixes is also contained in the record; and
if none of the plurality of query keyword prefixes is found through an object filter, performing an AND operation among child filter search results of the plurality of query keyword prefixes.

24. The computer-implemented method of claim 19, further comprising:
expanding the query keyword prefix to a prefix expansion including a plurality of prefixes that has an edit-distance e from the query keyword prefix;
traversing the multilayered spatial tree using the prefix expansion until a termination condition occurs; and
performing an OR operation among the plurality of prefixes in the same prefix expansion.

25. A computer-implemented information retrieval system for retrieving information from a dataset of multiple records, the system comprising:
a frontend module for receiving and parsing a search phrase from a user or client application, the search phrase having a query keyword prefix; and
a backend module for traversing a multilayered spatial tree using the query keyword prefix until a termination condition occurs, the multilayered spatial tree being constructed using geographic information and having a root node and a plurality of child nodes including a plurality of leaf nodes each associated with a corresponding list of records, wherein at least some nodes are each associated with a corresponding hybrid filter including an object filter and a child filter, the object filter directly pointing to one or more records, and the child filter pointing to one or more child nodes for a subsequent traversal step.
